(19) United States
(12) Patent Application Publication
(10) Pub. No.: US 2012/0130064 A1
(43) Pub. Date: May 24, 2012

(54) METHOD FOR THE HYDROPHILIC PROCESSING OF CELLULOSE FIBRE AND PRODUCTION METHOD FOR HYDROPHILIC CELLULOSE FIBRE

(75) Inventors: Akira Isogai, Tokyo (JP); Tsuguyuki Saito, Tokyo (JP); Chiaki Tanaka, Ayabe-shi (JP); Yoshinari Yui, Ayabe-shi (JP)

(73) Assignees: GUNZE LIMITED, Ayabe-shi, Kyoto (JP); THE UNIVERSITY OF TOKYO, Tokyo (JP)

(21) Appl. No.: 13/388,211

(22) PCT Filed: Aug. 24, 2010
(86) PCT No.: PCT/JP2010/064275

§ 371 Date: Jan. 31, 2012

(30) Foreign Application Priority Data
Aug. 25, 2009 (JP) 2009-194866

(51) Int. Cl. C08B 15/02

(52) U.S. Cl. 536/56

(57) ABSTRACT

This invention provides a method for hydrophilic treatment of cellulose fibers that can prevent coloring or decrease in fiber strength. The hydrophilic treatment method comprises a first oxidation step of oxidizing cellulose fibers in a first reaction solution containing an N-oxyl compound and a re-oxidizing agent for the N-oxyl compound; and a second oxidation step of oxidizing oxycellulose fibers obtained in the first oxidation step in a second reaction solution containing an oxidizing agent for oxidizing aldehyde groups.

### TECHNICAL FIELD

The present invention relates to a method for hydrophilic treatment of cellulose fiber and a method for producing hydrophilic cellulose fiber.

### BACKGROUND ART

Heretofore, high moisture-absorbing and moisture-releasing properties have been indispensable functions for cotton clothing products (cellulose fiber products), such as underwear, and are regarded as factors to differentiate the various products. One typical method for hydrophilic treatment of cellulose fiber among various methods is oxidation of the hydroxyl group in the cellulose into a carboxyl group.

For example, Patent Documents 1 and 2 disclose a method for oxidizing the primary hydroxyl group of β-glucose to a carboxyl group using sodium hypochlorite as the main oxidizing agent. Unlike partial carboxylmethylation using alkali and monochloroacetic acid, or carboxylation that adds N₂O₄ to chloroform, this method does not use toxic or deleterious substances, thus enabling safe and efficient introduction of a carboxyl group.

### CITATION LIST

[Patent Document 1] Japanese Unexamined Patent Publication No. 10-251302
[Patent Document 2] Japanese Unexamined Patent Publication No.

### SUMMARY OF INVENTION

### Technical Problem

In the aforementioned hitherto known treatment method, a sodium hypochlorite (NaClO) aqueous solution, which serves as the main oxidizing agent, is added to an aqueous dispersion of cellulose fiber containing a catalytic amount of NaBr and TEMPO so as to facilitate oxidation reaction (TEMPO-catalyzed oxidation reaction). In this treatment method, the pH value decreases due to generation of a carboxyl group during the reaction; therefore, a dilute sodium hydroxide aqueous solution (generally, NaOH of about 0.5 M) is constantly added to the reaction system to keep the pH value of the system in a range of 8 to 11.

FIGS. 5 and 6 show a mechanism for oxidizing the primary hydroxyl group of cellulose to a carboxyl group via aldehyde, using sodium hypochlorite, which serves as the main oxidizing agent, and a catalytic amount of sodium bromide (NaBr) and TEMPO.

As shown in FIG. 7(a), native cellulose is composed of crystalline microfibril units (composed of 30 to 100 cellulose molecules at a crystallinity of 65 to 95%). The above method selectively oxidizes only the C6 primary hydroxyl group on the microfibril surface of native cellulose into a carboxyl or aldehyde group while retaining the high crystalline structure of cellulose microfibril, thereby making cellulose fibers hydrophilic.

However, further research conducted by the present inventors revealed problems of the hitherto known treatment method, and cellulose fibers produced by the method, as described below.

(1) First, it was found that the hydrophilic cellulose fibers produced by the hitherto known treatment method had significantly poorer fiber strength.

In view of this problem, an object of the present invention is to provide a method for hydrophilic treatment of cellulose fibers and a method for producing hydrophilic cellulose fibers that can retain the fiber strength.

(2) It was also found that hydrophilic cellulose fibers produced by the hitherto known treatment method undergo a color change by heat. This may deteriorate the quality when the fibers are used for pure-white clothing.

In view of this problem, another object of the present invention is to provide a hydrophilic treatment method and a method for producing such hydrophilic cellulose fibers that can produce hydrophilic cellulose fibers that suffer no color change by heat.

(3) Another problem is that although more carboxyl groups are introduced in the cellulose fiber surface through the first and second oxidation steps and a dehalogenation step, along with the carboxylation of the C6 position of the cellulose fiber, the C2 and C3 positions of the fiber are also oxidized partially, thereby generating ketones.

In view of this problem, still another object of the present invention is to provide a method for producing a hydrophilic treatment method and hydrophilic cellulose fiber that further comprise, after the aforementioned steps, a reduction process that is performed to reduce the generated ketones using a reducing agent.

### Technical Solution

In order to solve the foregoing problem, a method for hydrophilic treatment of cellulose fiber and a method for producing hydrophilic cellulose fiber according to the present invention comprise a first oxidation step of oxidizing cellulose fibers in a first reaction solution containing a N-oxyl compound and a re-oxidizing agent for the N-oxyl compound, and a second oxidation step of oxidizing oxycellulose fibers obtained in the first oxidation step in a second reaction solution containing an oxidizing agent for oxidizing aldehyde group.

This method oxidizes the hydroxyl group at the C6 position of the cellulose in the first oxidation step and thereby introduces aldehyde and carboxyl groups into cellulose, and then oxidizes the aldehyde group generated in the first oxidation step into a carboxyl group in the second oxidation step. This method enables prompt oxidation required for the particular characteristic of cellulose fibers in the first oxidation step and enables substitution of aldehyde group, which may cause a degradation or color change, with carboxyl group in the second oxidation step. By performing these steps, the present invention accomplished a method for hydrophilic treatment of cellulose fibers and a method for producing hydrophilic cellulose fiber, which can solve the above problems (1) and (2).

In the hitherto known treatment method, TEMPO-catalyzed oxidation is performed in weak alkaline conditions with the pH value of 8 to 11 until a desired hydrophilicity is obtained. Therefore, as shown in the center of FIG. 8, aldehyde (CHO) is generated in the C6 position as an intermediate. This aldehyde very easily undergoes β-elimination reaction in the condition with the pH value of 8 to 11; therefore, presumably, the molecular chain of cellulose breaks as shown on the right-hand side of FIG. 8, thereby decreasing the strength of the resulting cellulose fibers.

Further, in the hitherto known treatment method, the aldehyde group generated on the cellulose microfibril surface remains even after the cellulose fiber has been washed, though its amount is less than the carboxyl group, namely, 0.5 mmol/g or less (generally 0.3 mmol/g or less). The remaining aldehyde group is assumed to cause color change due to the same reaction as caramelization of reducing sugars having aldehyde group.

In contrast, even though the first oxidation step produces aldehyde, the method of the present invention rapidly oxidizes the aldehyde in the second oxidation step, thereby producing substantially aldehyde-free oxycellulose. Accordingly, the present invention prevents breakage of a cellulose molecular chain due to reaction of the aldehyde group, thereby producing hydrophilic cellulose fibers with excellent strength. Further, since the hydrophilic cellulose fiber produced by the method of the present invention is aldehyde-free, it suffers no color change even after a heating process or a drying process by heating. Accordingly, the present invention produces hydrophilic cellulose fibers having a high degree of whiteness.

The above method is preferably performed such that the pH value of the first reaction solution is not less than 8 and not more than 12, and the pH value of the second reaction solution is not less than 3 and not more than 7.

According to this method, the first oxidation step efficiently facilitates reaction of the hydroxyl group at the C6 position of cellulose, and the second oxidation step efficiently facilitates oxidation reaction of the aldehyde group into a carboxyl group, thereby rendering the cellulose fiber hydrophilic while maintaining its strength and preventing color change by heating. In particular, by adjusting the condition of the second reaction solution used in the second oxidation step from acidic to neutral, it is possible to prevent β-elimination reaction caused by weak alkaline to strong alkaline conditions, thereby preventing a decrease in fiber strength during the second oxidation step caused by the aldehyde group introduced in the first oxidation step.

The above method is preferably performed such that a halogen oxidizing agent is used as the re-oxidizing agent or the oxidizing agent for oxidizing the aldehyde group, and the method further comprises a dehalogenation step of the oxycellulose fiber obtained in the second oxidation step.

This method prevents residual chlorine in the cellulose fiber after the hydrophilic treatment, thereby preventing a decrease in whiteness degree or embrittlement of the cellulose fiber caused by the residual chlorine.

The above method is preferably performed such that a hypohalous acid or a salt thereof is used as the re-oxidizing agent, and a halous acid or a salt thereof is used as the oxidizing agent for oxidizing the aldehyde group.

Use of these oxidizing agents enables efficient oxidation reaction of the primary hydroxyl group at the C6 position of the cellulose in the first oxidation step and also enables efficient oxidation reaction of the aldehyde group at the C6 position into a carboxyl group in the second oxidation step.

It is also possible to use a mixture of hydrogen peroxide and oxydase, or a peracid as the oxidizing agent for oxidizing the aldehyde group.

The above method is preferably performed such that a buffer is added to the second reaction solution.

In this method, it is not necessary to add an acid or alkali to maintain pH; thereby, the method does not require a pH meter.

This advantage enables the reaction vessel to be hermetically sealed in the second oxidation step. This further makes it possible to apply heat or pressure to the reaction system. In addition, the hermetically sealed reaction vessel prevents leakage of the gas generated from the reaction solution to outside the reaction system, thereby increasing the safety level of the hydrophilic treatment method. Furthermore, this also prevents diffusion of gas generated by decomposition of the oxidizing agent into the atmosphere. This is conducive to reducing the amount of oxidizing agent.

The above method is preferably performed such that a penetrant is added to the first reaction solution.

This method enables the oxidation to proceed into the inner portion of the cellulose fiber in the first oxidation step, thereby increasing the degree of hydrophilic treatment.

The first oxidation step may be performed such that the oxidation is carried out by immersing the cellulose fibers in a treatment bath of a solution containing an N-oxyl compound and adding a required amount of the re-oxidizing agent to the treatment bath.

This method enables precise adjustment of the amount of the re-oxidizing agent to be added to the reaction system to an amount substantially conducive to the reaction in first oxidation step. This is conducive to reducing the amount of re-oxidizing agent, thereby reducing the cost of the hydrophilic treatment.

The above method is preferably performed such that the re-oxidizing agent is added while keeping the pH value of the treatment bath constant.

By thus adding the re-oxidizing agent to the treatment bath based on the pH value, it becomes possible to supply the re-oxidizing agent in an exact amount required with the progression of the oxidation reaction of the cellulose fiber, thereby more efficiently using the re-oxidizing agent.

The above method preferably further comprises a reduction step for reducing the oxycellulose fiber obtained in the second oxidation step in a reaction solution containing a reducing agent.

This process is conducive to reducing ketones generated in a part of the C2 position or C3 position of the cellulose fiber.

The above method is preferably performed such that the reducing agent used in the reduction step is at least one member selected from the group consisting of thiourea dioxide, hydrosulfite, sodium hydrogen sulfite, sodium borohydride, sodium cyanoborohydride, and lithium borohydride.

By thus using the specific reducing agent, it becomes possible to reduce the ketone group in the C2 position or C3 position of the cellulose fiber without reducing the carboxyl group at the C6 position.

The hydrophilic cellulose fiber obtained by the method of the present invention has a structure such that at least a part of the hydroxyl group residing on the cellulose microfibril surface is oxidized only into a carboxyl group.

The above hydrophilic cellulose fiber in which the part of the hydroxyl group is oxidized only into a carboxyl group has less than 0.05 mmol/g of aldehyde content.

The above hydrophilic cellulose fiber has a strength and a whiteness degree equivalent to those of a fiber not subjected to hydrophilic treatment; moreover, the hydrophilic cellulose fiber has a greatly increased hygroscopic property.

The above hydrophilic cellulose fiber may be applied to various fiber products. By using the cellulose fibers produced by the treatment method of the present invention, it is possible to provide various fiber products, including clothing articles, general merchandise, interior accessories, bedding, and industrial materials, which can maintain a desired strength and whiteness while ensuring an improved hygroscopic property.

### Advantageous Effects of Invention

The cellulose fiber hydrophilic treatment method of the present invention enables oxidation of the primary hydroxyl group residing on the cellulose microfibril surface only to a carboxyl group, thereby obtaining a cellulose fiber of desired strength, which does not undergo a color change even after a heating process.

### BRIEF DESCRIPTION OF DRAWINGS

FIG. 1: Drawings showing a mechanism of a hydrophilic treatment method of the present invention and generation of a carboxyl group.

FIG. 2: Drawings showing treatment devices used for the hydrophilic treatment method of the present invention.

FIG. 3: Drawings showing experiment devices used in an Example.

FIG. 4: Graphs corresponding to tables.

FIG. 5: A drawing showing a cellulose oxidation mechanism used in a hitherto known treatment method.

FIG. 6: A drawing showing a cellulose oxidation mechanism used in a hitherto known treatment method.

FIG. 7: A drawing showing structure models of cellulose microfibril.

FIG. 8: A drawing showing molecular chain breakage due to β-elimination reaction.

### DESCRIPTION OF EMBODIMENTS

An embodiment of the present invention is described below in reference to drawings.

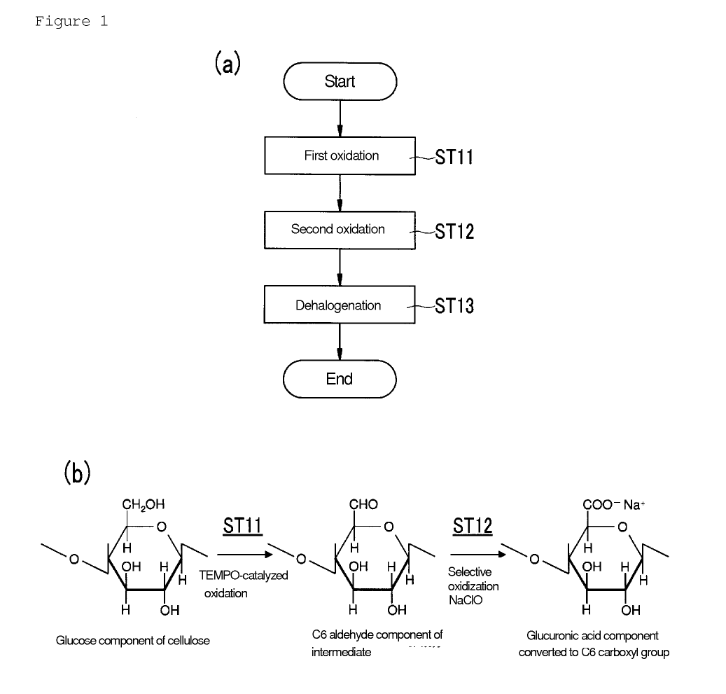

As shown in FIG. 1(a), the method for producing hydrophilic cellulose fibers (cellulose nanofibers) according to the present Example comprises:

a first oxidation step ST11 of oxidizing cellulose fiber in a first reaction solution containing a N-oxyl compound and a re-oxidizing agent for the N-oxyl compound;

a second oxidation step ST12 of oxidizing oxycellulose fibers obtained in the first oxidation step in a second reaction solution containing a oxidizing agent for oxidizing aldehyde group; and

a dehalogenation step ST13 for carrying out dehalogenation of the oxycellulose fibers resulting from the second oxidation step ST12.

As shown in FIG. 1(b), the first oxidation step ST11 selectively oxidizes the primary hydroxyl group of the glucose component residing in the cellulose fiber microfibril surface into an aldehyde group or a carboxyl group. The second oxidation step ST12 selectively oxidizes the aldehyde group generated in the first oxidation step ST11. Through these steps, the present invention obtains aldehyde-free oxycellulose fibers.

First Oxidation Step

First, the first oxidation step ST11 is described below.

Examples of cellulose fibers to be subjected to the treatment of the present invention include native cellulose fibers derived from a plant, an animal, or a bacteria-derived gel, and regenerated cellulose fibers. Specific examples thereof include native cellulose fibers, such as cotton, hemp, pulp, or bacteria cellulose, and regenerated cellulose fibers, such as rayon or cupra.

The form of the cellulose fiber material is not limited to woven and non-woven fabrics, and includes filamentous articles such as filaments, staples, and strings. The contexture of the fiber may be varied, including combined filament, mixed spun, union fabric, mixed woven, and mixed knitted.

A typical solvent of the reaction solution is water. An N-oxyl compound represented by the following formula is used as the catalyst to be added to the reaction solution.

The N-oxyl compound is represented by following formula:

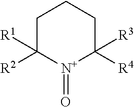

wherein R¹ to R⁴, which are the same or different, each represent an alkyl group having about 1 to 4 carbon atoms.

Examples of N-oxyl compounds include TEMPO (2,2,6,6-tetramethylpiperidine-N-oxyl) and TEMPO derivatives (such as 4-acetamide TEMPO, 4-carboxyl TEMPO, 4-phosphonooxy TEMPO, 4-amino-TEMPO, 4-(2-bromoacetamide)-TEMPO, 4-hydroxy TEMPO, 4-oxy TEMPO, 4-methoxy TEMPO, 2-azaadamantane N-oxyl and the like) which have various functional groups at the C4 position. In particular, TEMPO, 4-methoxy TEMPO, and 4-acetamide TEMPO are verified for the reaction speed.

A sufficient effect is ensured from addition of a catalytic amount of an N-oxyl compound. More specifically, the amount of the N-oxyl compound ranges from 0.01 to 3 g/L based on the amount of the reaction solution. Because the addition amount of the N-oxyl compound does not greatly affect the degree of the hydrophilic treatment or the quality of the resulting cellulose fiber, it preferably ranges from 0.1 to 2 g/L for cost savings.

A hypohalous acid or a salt thereof is used as the oxidizing agent in the first oxidation step ST11.

The content of the oxidizing agent in the first reaction solution is preferably in a range of 0.05 to 5 g/L.

Examples of halogens constituting the hypohalous acid include chlorine, bromine, and iodine, specifically, hypochlorous acid, hypobromous acid, and hypoiodous acid.

Examples of metallic salts that form a hypohalite include alkali metal salts such as lithium, potassium, or sodium; alkaline-earth metal salts, such as calcium, magnesium, or strontium; and a salt of ammonium and hypohalous acid.

More specifically, examples of hypochlorous acids include lithium hypochlorite, potassium hypochlorite, sodium hypochlorite, calcium hypochlorite, magnesium hypochlorite, strontium hypochlorite, ammonium hypochlorite, and corresponding hypobromites and hypoiodites.

Among these, a hypohalous acid alkali metal salt is preferably used as the oxidizing agent in the first oxidation step ST11. A hypochlorous acid alkali metal salt (such as sodium hypochlorite) is more preferable.

Further, in the first oxidation step ST11, it is also possible to use a catalyst component formed of a combination of an N-oxyl compound and a promoter. Examples of promoters include salts of halogen and alkali metal, salts of halogen and alkali earth metal, ammonium salts, and sulfates. Examples of halogen include chlorine, bromine, and iodine. Examples of alkali metal include lithium, potassium, and sodium. Examples of alkali earth metal include calcium, magnesium, and strontium.

More specifically, lithium bromide, potassium bromide, sodium bromide, lithium iodide, potassium iodide, sodium iodide, lithium chloride, potassium chloride, sodium chloride, calcium bromide, magnesium bromide, strontium bromide, calcium iodide, magnesium iodide, strontium iodide, calcium chloride, magnesium chloride, strontium chloride and the like may be used.

Examples of ammonium salts include ammonium bromides, ammonium iodides, and ammonium chlorides. Further, examples of sulfates include sodium sulfates (salt cake), sodium hydrogensulfates, and alum. These promoters may be used singly or in a combination of two or more.

In the first oxidation step ST11, the pH value of the first reaction solution is preferably kept in the range of 8 to 12, more preferably in the range of 10 to 11, which is a suitable range to allow the oxidized TEMPO to act on the cellulose fibers.

The pH value of the reaction solution may be adjusted by adding a basic substance (ammonia, potassium hydroxide, sodium hydroxide, etc.) or acidic substance (organic acid, such as acetic acid, oxalic acid, succinic acid, glycolic acid, malic acid, citric acid, or benzoic acid; or inorganic acid, such as nitric acid, hydrochloric acid, sulfuric acid, or phosphate) as appropriate.

It is also possible to add a penetrant to the first reaction solution ST11 used in the first oxidation step ST11. Examples of penetrants include known penetrants for cellulose fibers, namely, anionic surfactants (carboxylate, alkyl sulfate, sulfonate, phosphate etc.) and nonionic surfactants (polyethyleneglycol-based, polyalcohol-based, etc.), such as Shintol (product name of Takamatsu Oil & Fat Co., Ltd.), etc.

By adding a penetrant to the first reaction solution, it is possible to allow the chemical agents to infiltrate into the cellulose fibers, thereby introducing more carboxyl groups (aldehyde groups) into the cellulose fiber surface. This increases hydrophilicity (hygroscopic property) of the cellulose fibers.

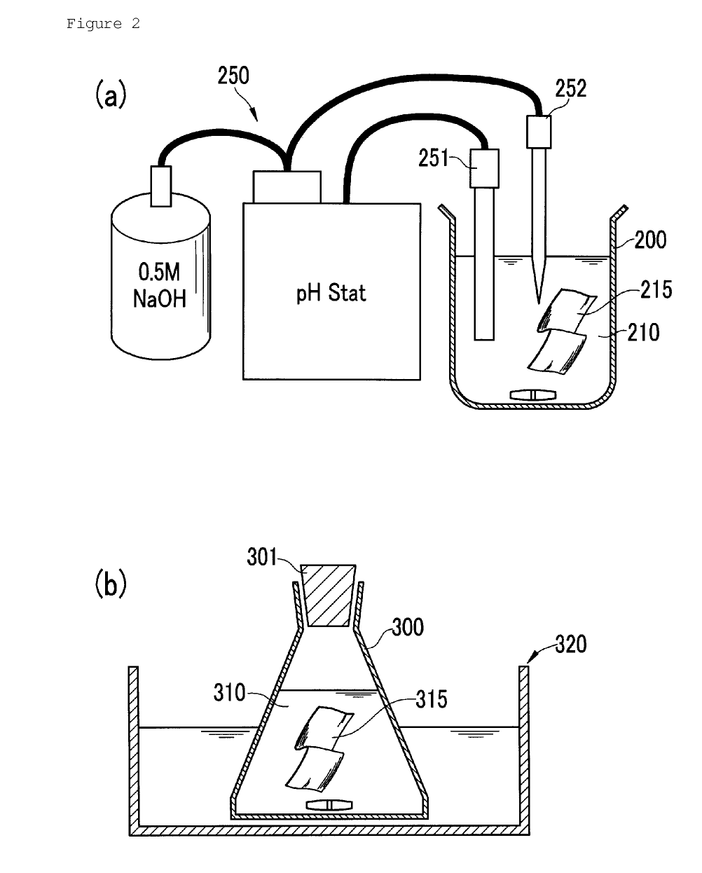

FIG. 2(a) is a drawing showing an embodiment of a treatment device used in the first oxidation step ST11.

In the first oxidation step ST11, a first reaction solution 210 is prepared by dissolving an N-oxyl compound (TEMPO etc.), an alkali metal bromide serving as a promoter, and a sodium hypochlorite (hypochlorite) serving as a re-oxidizing agent in water in a reaction vessel 200. The treatment device is equipped with a pH value adjustment device 250. The pH value adjustment device 250 comprises a pH electrode 251 for measuring the pH value and a nozzle 252 for supplying a dilute sodium hydroxide aqueous solution for adjusting the pH value. The pH electrode 251 and the nozzle 252 are placed in the first reaction solution 210 from an upper opening of the reaction vessel 200. A cellulose fiber 215 is placed in the first reaction solution 210 to be immersed therein, and oxidation reaction is advanced, as required, with stirring, at a temperature from 0° C. to room temperature (10° C. to 30° C.).

In the first oxidation step ST11, the pH value of the reaction solution decreases due to the generation of a carboxyl group with the progress of the reaction. Therefore, to sufficiently facilitate the oxidation reaction, an aqueous solution or the like containing an alkali metal component, such as a sodium hydroxide aqueous solution, is added to the first reaction solution 210, thereby keeping the pH of the reaction system within an alkaline range (pH value of 8 to 12, more preferably 10 to 11). Further, in the first oxidation step ST11, because the pH value of the reaction solution decreases only while the oxidation reaction is advanced, it is possible to determine the end point of the reaction to be at a time when the decrease in pH value stops.

After the reaction, a treatment for decomposing the oxidizing agent (sodium hypochlorite, etc.) is performed as required. Thereafter, the resulting fibers are repeatedly washed with water to obtain oxycellulose fibers.

The reaction temperature in the first oxidation step ST11 may be higher than room temperature. By advancing the reaction under a high temperature, it is possible to increase reaction efficiency. On the other hand, a high temperature more easily generates chlorine gas from the sodium hypochlorite; therefore, it is preferable to use a chlorine gas treatment device during the reaction at a high temperature.

The treatment in the first oxidation step ST11 is not limited to that performed in the above Example in which the cellulose fibers are immersed into the first reaction solution containing an N-oxyl compound, an alkali metal bromide (sodium bromide, etc.), and a re-oxidizing agent (sodium hypochlorite).

For example, the treatment may be performed by adding a sodium hypochlorite (re-oxidizing agent) to a treatment solution bath containing a N-oxyl compound and an alkali metal bromide while immersing cellulose fiber in the bath. In this method, the pH value of the treatment bath is observed and a sodium hypochlorite is added dropwise to keep the pH constant (for example, at 10).

This treatment method enables supply of sodium hypochlorite to the treatment bath only in an amount required for the reaction of cellulose fibers. Therefore, it is possible to reduce the amount of sodium hypochlorite not conducive to the reaction, thereby reducing the cost for hydrophilic treatment.

Second Oxidation Step

The second oxidation step ST12 is described below.

The material used in the second oxidation step ST12 is oxycellulose fibers obtained in the first oxidation step ST11. More specifically, the material of this step is oxycellulose fibers that are made from cellulose fibers subjected to the oxidation in the first reaction solution containing a N-oxyl compound and the re-oxidizing agent thereof (hypohalous acid or a salt thereof).

The oxidizing agent used in the second oxidation step ST12 is an oxidizing agent capable of oxidizing an aldehyde group to convert it into a carboxyl group. Specific examples of the oxidizing agents include halous acids or salts thereof (such as chlorous acid or a salt thereof, bromous acid or a salt thereof, or iodous acid or a salt thereof), peracid (such as hydrogen peroxide, peracetic acid, persulfuric acid, or perbenzoic acid). These oxidizing agents may be used singly or in a combination of two or more. These oxidizing agents may be combined with an oxydase such as laccase. The content of the oxidizing agent may be appropriately set; however, the content preferably ranges from 0.01 to 50 mmol/g based on the amount of cellulose fibers.

Examples of halogens constituting the halous acid salt include chlorine, bromine, and iodine. Examples of the salts forming the halous acid salts include lithium, potassium, sodium and like alkali metal salts; calcium, magnesium, strontium and like alkaline-earth metal salts; and ammonium salts. For example, in the case of chlorites, examples include lithium chlorite, potassium chlorite, sodium chlorite, calcium chlorite, magnesium chlorite, strontium chlorite, and ammonium chlorite, as well as corresponding bromous acid salts and iodous acid salts.

Examples of preferable oxidizing agents to be used in the second oxidation step ST12 include halous acid alkali metal salts, more preferably, chlorous acid alkali metal salts.

In the second oxidation step ST12, the oxycellulose fibers obtained in the first oxidation step ST11 are oxidized by being immersed in the second reaction solution containing an oxidizing agent capable of oxidizing aldehyde into carboxyl, thereby converting the aldehyde generated at the C6 position of the cellulose in the first oxidation step ST11 into carboxyl. This prevents color change by heat or β-elimination reaction caused by the aldehyde group generated at the C6 position of the cellulose, thereby producing hydrophilic cellulose fibers without deteriorating the strength of the material.

In the second oxidation step ST12, the pH value of the reaction solution is kept between neutral and acidic. More specifically, the pH value of the reaction solution is kept between 3 and 7. In particular, it is important to keep the pH value of the reaction solution to 8 or less. By keeping the pH value within this range, it is possible to convert the aldehyde group into a carboxyl group while preventing β-elimination reaction caused by the aldehyde group generated at the C6 position of the cellulose in the first oxidation step ST11, thereby performing hydrophilic treatment of cellulose fibers without decreasing the fiber strength.

Further, it is preferable to add a buffer to the second reaction solution. Various buffers, including phosphate buffers, acetic acid buffers, citric acid buffers, borate buffers, tartaric acid buffers, tris buffers and the like, may be used.

By thus preventing fluctuations in pH during the reaction by using a buffer, it becomes unnecessary to sequentially add acids and alkalis to maintain pH, or to install a pH value meter. Since the addition of acids and alkalis is not necessary, the reaction vessel may be hermetically sealed.

FIG. 2(b) is a drawing showing an embodiment of a treatment device used in the second oxidation step ST12.

In the second oxidation step ST12, a second reaction solution 310, which contains sodium chlorite (chlorous acid salt) serving as an oxidizing agent, is prepared in a reaction vessel 300. Then, the oxycellulose fiber 315 obtained in the first oxidation step ST11 is immersed in the second reaction solution 310. Then, the reaction vessel 300 is hermetically sealed with a cap 301. Thereafter, the second reaction solution 310 is kept in a range from room temperature to 100° C. using a heating device such as a hot water tank 320. The oxidation reaction is advanced under this condition, as required, with stirring. After the oxidation reaction is completed, the oxidation reaction is terminated as required. The reaction mixture is repeatedly washed with water to obtain an oxycellulose fiber.

Since the reaction vessel 300 can be hermetically sealed in the second oxidation step ST12, the reaction vessel 300 can be equipped with a pressure device for elevating pressure inside the vessel.

Dehalogenation Step

The dehalogenation step ST13 is explained below.

The oxycellulose fibers obtained in the second oxidation step ST12 are used as the material for the dehalogenation step ST13. More specifically, the material used in this step is oxycellulose fibers resulting from the TEMPO oxidation in the first oxidation step ST11 and the second oxidation step ST12, whereby the aldehyde group was converted into a carboxyl group.

In the treatment method according to the present embodiment, a halous acid or a salt thereof is used as the oxidizing agent in the second oxidation step ST12, and a hypohalous acid or a salt thereof is used as a re-oxidizing agent in the first oxidation step ST11. Therefore, a halogen atom derived from the halous acid or hypohalous acid is attached or bonded to the resulting oxycellulose fiber after the oxidation. Typically, sodium hypochlorite is used in the first oxidation step ST11, and sodium chlorite is used in the second oxidation step ST12; therefore, chlorine is attached or bonded to the oxycellulose fiber after the oxidation.

Therefore, in order to remove residual halogens from the oxycellulose fibers, dehalogenation (dechloridation) is performed in the treatment method of the present embodiment. The dehalogenation is performed by immersing the oxycellulose fibers in a hydrogen peroxide solution or an ozone solution.

More specifically, for example, the oxycellulose fibers are immersed in a hydrogen peroxide solution having a concentration of 0.1 to 100 g/L at a bath ratio of about 1:5 to 1:100, preferably about 1:10 to 1:60 (weight ratio). The concentration of the hydrogen peroxide solution is preferably 1 to 50 g/L, more preferably 5 to 20 g/L. The pH value of the hydrogen peroxide solution preferably ranges from 8 to 11, more preferably from 9.5 to 10.7.

In the above hydrophilic treatment method, a hypohalous acid or a salt thereof is used as the first reaction solution serving as a re-oxidizing agent for TEMPO in the first oxidation step ST11, and the reaction proceeds under a pH of 8 to 11, at which these oxidizing agents most efficiently work. Therefore, the TEMPO oxidation of the cellulose fibers is efficiently facilitated. The treatment of the first oxidation step ST11 of the present invention is completed in several minutes to 20 minutes, although it depends on the amount of the re-oxidizing agent or the amount of the cellulose fibers to be treated.

On the other hand, the first oxidation step ST11 produces aldehyde-containing oxycellulose fibers. More specifically, the TEMPO oxidized by the re-oxidizing agent oxidizes the primary hydroxyl group at the C6 position of the cellulose into an aldehyde group. As a result, a part of the aldehyde group is oxidized into a carboxyl group. It is very unlikely, however, that the entire aldehyde is oxidized; some residue always remains. The residual aldehyde group remaining in the oxycellulose fiber causes β-elimination reaction in the alkaline first reaction solution, breaking the molecular chains of the cellulose, decreasing the polymerization degree of the oxycellulose, and thereby decreasing the strength of the oxycellulose fiber. Moreover, the aldehyde-containing oxycellulose undergoes a color change by heat.

In view of these problems, the second oxidation step ST12 is performed in the present invention so as to oxidize the aldehyde group of the oxycellulose obtained in the first oxidation step ST11. By performing the second oxidation step ST12, it is possible to obtain oxycellulose fibers that are almost aldehyde-free, thereby preventing the decrease in strength caused by the β-elimination reaction of the aldehyde group or color change by heat caused by the aldehyde group. Further, in the present invention, the pH value of the second reaction solution is adjusted to 3 to 7, thus preventing of β-elimination reaction of the aldehyde group during the process of the second oxidation step ST12.

As such, the hydrophilic treatment method according to the present embodiment enables the hydrophilic treatment to be efficiently and quickly done. Moreover, the hydrophilic cellulose fibers obtained by the hydrophilic treatment of the present embodiment have superior strength and do not undergo a color change by heat.

Reduction Treatment

The first and second oxidation steps and the dehalogenation step explained above allow introduction of a greater carboxylate contents into the cellulose fiber surface of the cellulose fibers; however, in some cases, the fibers turn yellow discoloration by the oxidation step (decrease in whiteness). This is presumably because the oxidation step, which induces carboxylation of the C6 position, also oxidizes a part of the C2 and C3 positions of the cellulose fiber, thereby generating ketone. To prevent such color change (decrease in whiteness) of the hydrophilic cellulose fibers, a reduction treatment using a reducing agent is performed after the above steps so as to reduce the generated ketone.

The reducing agent is selected from those capable of reducing the partially produced ketone to alcohol but incapable of reducing the generated carboxyl group. Specific examples of the reducing agents include thiourea, hydrosulfite, sodium hydrogen sulfite, sodium borohydride, sodium cyanoborohydride, and lithium borohydride. Among these, in view of ensuring excellent initial whiteness and preventing decrease in whiteness, sodium borohydride and sodium hydrogen sulfite are preferable.

The solvent for the reaction solution containing a reducing agent may be ordinary water or other various different kinds of water including distilled water, ion-exchanged water, well water, and tap water. The concentration of the reducing agent in the reaction solution is preferably in a range of 0.02 to 4 g/L, more preferably 0.2 to 2 g/L. With this limited concentration, embrittlement of the fabric caused by an excessive amount of reducing agent can be suppressed.

The pH value of the reaction solution used in the reduction treatment using a reducing agent is preferably about 7 or more, more preferably about 7.5 or more, further preferably about 8 or more in view of retaining desirable activity of the reducing agent. Further, the pH value of the reaction solution used in the reduction treatment using a reducing agent is preferably about 12 or less, more preferably about 11 or less, further preferably about 10 or less in view of preventing embrittlement of the fabric in alkaline environments. The pH value of the reaction solution can be adjusted by adding ammonia water, hydrochloric acid, soda ash, NaOH, KOH, etc., as appropriate.

The reaction temperature in the reduction treatment using a reducing agent is appropriately varied depending on the type or addition amount of the reducing agent. However, the reaction temperature is preferably in a range of about 10 to 80° C., more preferably about 20 to 40° C.

In the hydrophilic cellulose fibers (oxycellulose fibers) obtained by the above-described hydrophilic treatment method of the present invention, at least a part of the hydroxyl group residing in the cellulose microfibril surface is oxidized only by a carboxyl group. The hydrophilic cellulose fibers are also defined as cellulose fibers containing an aldehyde group in an amount of less than 0.05 mmol/g.

More specifically, the above hydrophilic cellulose fibers are hydrophilic cellulose fibers containing no aldehyde at all at the C6 position of the cellulose microfibril surface, or may be regarded as such hydrophilic cellulose fibers. The hydrophilic cellulose fibers regarded as hydrophilic cellulose fibers containing no aldehyde at all are equivalent to hydrophilic cellulose fibers containing less than 0.05 mmol/g of aldehyde group. This range of aldehyde content ensures prevention of decrease in fiber strength (bursting strength) and prevention of coloring by heat. The aldehyde content is more preferably 0.01 mmol/g or less, further preferably 0.001 mmol/g or less.

According to the currently known measurement methods, the detection limit of aldehyde group is about 0.001 mmol/g. Therefore, in a preferred embodiment, no aldehyde group is detected from the hydrophilic cellulose fibers in the measurement.

Further, in the hitherto known treatment methods, TEMPO catalyzed oxidation always generates a carboxyl group and aldehyde group. Therefore, the hydrophilic cellulose fibers of the present invention having the aforementioned characteristic are clearly distinguished from the cellulose fibers obtained by the hitherto known treatment method.

The aldehyde content can be measured, for example, according to the following steps.

First, a hydrophilic cellulose fiber sample is weighed (dry weight) and placed in water. After a 0.1 M hydrochloric aqueous solution is added to adjust the pH value to about 2.5, a 0.05 M sodium hydroxide aqueous solution is added dropwise, and electrical conductance is measured. The measurement is continued until the pH value reaches 11. The amount of functional group is determined according to the following equation based on the consumption of sodium hydroxide (amount of sodium hydroxide solution) (V) in the neutral condition of a weak acid in which the fluctuation in electrical conductance is relatively moderate. This amount of a functional group corresponds to the amount of a carboxyl group.

Amount of functional group(mmol/g)=V(ml)×0.05/mass(g) of cellulose

Thereafter, the hydrophilic cellulose fiber sample subjected to measurement of carboxyl content is further oxidized in a 2% sodium chlorite aqueous solution, which was adjusted in pH to 4 to 5 by adding an acetic acid, for 48 hours at room temperature. Then, the sample is again subjected to measurement of functional group content by the aforementioned method. The aldehyde content can be found by subtracting the carboxyl content from the measured amount of the functional group.

Because the hydrophilic cellulose fibers obtained by the hydrophilic treatment method of the present invention do not contain an aldehyde group at the C6 position, the coloring component derived from an aldehyde group is not produced when the fibers are heated. Therefore, the hydrophilic cellulose fibers are suitable for materials of underwear or similar clothing articles that require high whiteness. The hydrophilic cellulose fibers are also easy to handle, as they ensure stable quality even under heat and are resistant to various processes.

Moreover, the above hydrophilic cellulose fibers are protected from breakage of cellulose microfibril caused by the aldehyde group, which often occurs during the hydrophilic treatment. Therefore, the hydrophilic cellulose fibers ensure an improved hygroscopic property while hardly deteriorating the strength of the material of the cellulose fibers.

As described above, the hydrophilic cellulose fiber in which the primary hydroxyl group of the cellulose microfibril is oxidized to a carboxyl group has a superior hygroscopic property, thereby ensuring a further superior heat liberation effect or exothermic effect. With these advantages, the hydrophilic cellulose fiber is suitable for various fiber products.

Examples of the fiber products include clothing articles, general merchandise, interior accessories, bedding, and industrial materials.

Examples of clothing articles include outdoor garments, sportswear, homewear, relaxation wear, pajamas, nightwear, underwear, officewear, workwear, food manufacturing white coats, medical white coats, patient gowns, nursing care clothes, school uniforms, and chef coats. Examples of underwear include shirts, briefs, shorts, girdles, pantyhose, tights, socks, leggings, belly bands, long drawers, under long pants, and petticoats.

Examples of general merchandise include aprons, towels, gloves, scarves, hats, shoes, sandals, bags and umbrellas.

Examples of interior accessories include curtains, carpets, mats, kotatsu (small table with an electric heater underneath) covers, sofa covers, cushion covers, side fabric for sofas, toilet seat covers, toilet mats, and tablecloths.

Examples of bedding include side fabrics for bedding, filling cotton for bedding, blankets, side fabrics for blankets, fillers for pillows, sheets, waterproofing sheets, comforter covers, and pillow cases.

Examples of industrial materials include filters.

### EXAMPLES

The present invention is more specifically explained below with reference to Examples. However, the present invention is not limited to these Examples.

### Example 1

In this Example, hydrophilic treatment was performed on a 100% cotton knitted fabric (cellulose fiber) according to the hydrophilic treatment method of the present invention, and a functionality assessment of the resulting fabric (hydrophilic cellulose fiber) was made.

Test Conditions

### (a) Test Step

In this test, the first oxidation step ST11 for subjecting an unbleached sample fabric (cellulose fiber) to TEMPO oxidization, the second oxidation step ST12 for further oxidizing the oxycellulose fiber, the dehalogenation step ST13 for removing chlorine from the oxycellulose fiber, and a drying step for drying the treated sample fabric were sequentially performed.

In the present Example, the hydrophilic treatment in the first oxidation step ST11 for carrying out TEMPO oxidization was performed using two kinds of first reaction solutions, i.e., a solution to which a penetrant was added and a solution containing no penetrant, so as to confirm the infiltration of the chemical into the fabric.

### (b) TEMPO Oxidization (First Oxidation Step ST11)

The TEMPO oxidation of the fabric was performed under the condition shown in Table 1.

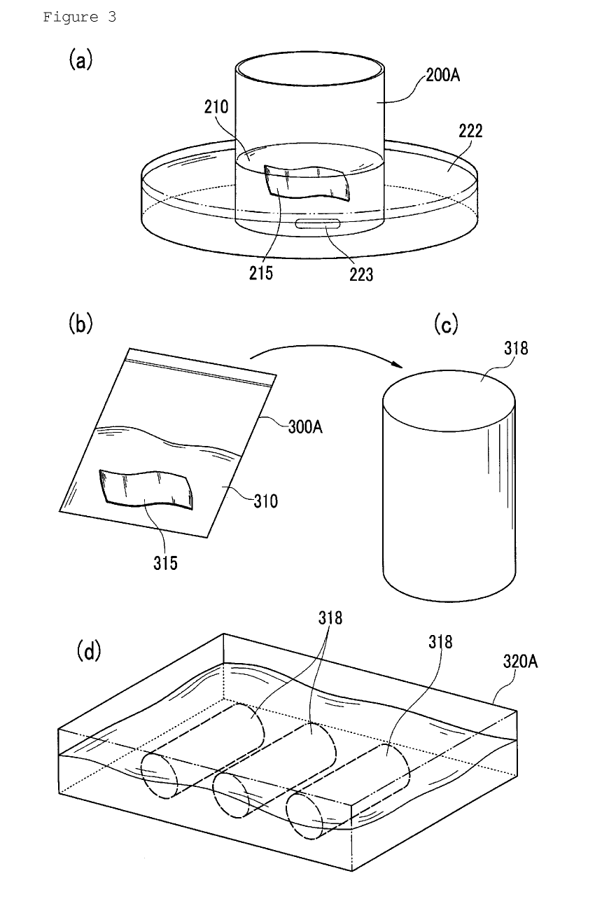

FIG. 3(a) is a schematic view of a treatment device used in the first oxidation step ST11. As shown in FIG. 3(a), the treatment is performed by placing a sample fabric 215 in a beaker 200A comprising a stirring bar 223, together with a first reaction solution 210, so as to be subjected to oxidation under open system. The beaker 200A is placed in a water bath 222 kept at a predetermined reaction temperature. The water bath 222 has a temperature controlling function.

A treatment bath was prepared by adding a TEMPO catalyst, sodium bromide, and a penetrant (Shintol G29 (product name of Takamatsu Oil & Fat Co., Ltd.)) in a beaker 200A. A sample fabric 215 was placed in the treatment bath so as to be fully immersed in the chemical agent. Thereafter, sodium hypochlorite (4.9% aqueous solution) was added to the treatment bath; further, 0.5 M hydrochloric acid was added to adjust the pH of the treatment bath (first reaction solution 210) to 10. Thereafter, the oxidation reaction was advanced by adding 1.0 M sodium hydroxide dropwise while keeping the pH of the treatment bath at 10. The reaction was stopped when the reaction time reached 15 minutes.

To create a sample containing no penetrant, the first oxidation step ST11 was performed with another sample under the same condition as in Table 1 except for the addition of penetrant.

TABLE 1

| Factor | Condition | |
|---|---|---|
| Weight of fabric | 20 | g |
| TEMPO catalyst | 0.08 | g/L |
| NaBr | 0.83 | g/L |
| 4.9% NaCl0 | 90 | g/L |
| Penetrant | 1 | g/L |
| pH | 10 | |
| Reaction temperature | 25° | C. |
| Reaction time | 15 | minutes |

| | |
|---|---|
| Initial bath ratio | 1:30 |
| (Fabric:Amount of reaction | |
| solution (weight ratio)) | |

### (c) Oxidation Step (Second Oxidation Step ST12)

The sample fabric (oxycellulose fiber) was subjected to another oxidation under the condition detailed in Table 2 so as to oxidize an aldehyde group, which is introduced into the cellulose in the preceding TEMPO oxidization, to a carboxyl group.

FIG. 3(b) is a schematic view of an experiment device used in the second oxidation step ST12. As shown in FIG. 3(b), a sample fabric (oxycellulose fiber) 315, which was subjected to TEMPO oxidation in the first oxidation step ST11, was placed in a vinyl bag 300A with a second reaction solution 310. The bag was hermetically sealed.

The sample sealed in the vinyl bag 300A was prepared as follows.

A second reaction solution 310 containing sodium chlorite (25% aqueous solution) and a chlorite bleaching chelating agent Neocrystal CG1000 (Nicca Chemical Co., Ltd) was prepared. 60 g of a sample fabric 315, which had been subjected to TEMPO oxidation in the first oxidation step ST11, was placed in the second reaction solution 310, followed by stirring. Then, the vinyl bag 300A was zipped to be hermetically sealed.

Next, the vinyl bag 300A was placed in a 3 L stainless steel pot 318 internally coated with fluororesin. The pot was hermetically sealed. Thereafter, the stainless steel pot 318 containing the sample fabric 315 sealed therein was placed in an oil bath 320A kept at 80° C. The oxidation reaction was advanced under temperature and time control by rotating the stainless steel pot 318 to stir the sample therein. The reaction was stopped when the reaction time reached 90 minutes.

TABLE 2

| Factor | Condition | |
|---|---|---|
| Weight of fabric | 60 | g |
| 25% NaCl0₂ | 20 | g/L |
| CG1000 | 1 | g/L |
| pH | 3.8 | |
| Reaction temperature | 80° | C. |
| Reaction time | 90 | minutes |

| | |
|---|---|
| Initial bath ratio | 1:20 |
| (Fabric:Amount of reaction | |
| solution (weight ratio)) | |

### (d) Dechlorination Step (Dehalogenation Step ST13)

Under the condition detailed in Table 3, chlorine was removed from the sample fabric oxidized in the second oxidation step ST12.

A reaction solution containing hydrogen peroxide (35% aqueous solution) and a polycarboxylic acid chelating agent Neorate PLC7000 (Nicca Chemical Co., Ltd) was prepared. 60 g of the sample fabric (oxycellulose fiber) oxidized in the second oxidation step ST12 was added to the reaction solution. The reaction solution was stirred while being kept at 70° C., thereby advancing the reaction. The reaction was stopped when the reaction time reached 20 minutes.

Further, in order to verify the effect of the second oxidation step ST12, another sample was prepared without performing the second oxidation step ST12, i.e., by performing the dechlorination step ST13 after the first oxidation step ST11.

TABLE 3

| Factor | Condition | |
|---|---|---|
| Weight of fabric | 60 | g |
| 35% H₂O₂ | 5% | owf |
| PLC7000 | 0.4 | g/L |
| pH | 10.6 | |
| Reaction temperature | 70° | C. |
| Reaction time | 20 | minutes |

| | |
|---|---|
| Initial bath ratio | 1:30 |
| (Fabric:Amount of reaction | |
| solution (weight ratio)) | |

### (e) Washing and Drying Step

The sample fabric thus subjected to the dechloridation step was washed sequentially with cold water (5 minutes, once), hot water (60° C., 10 minutes, once), and cold water (5 minutes, twice). Thereafter, the sample fabric was dried in a drying chamber kept at 40° C.

Evaluation Result

Table 4 shows evaluation results regarding moisture absorptivity and whiteness degree for the multiple samples (1-1, 1-2, 2-1, 2-2) prepared in the above test step.

Samples 1-1 and 1-2 are sample fabrics treated without a penetrant in the first oxidation step ST11. On the other hand, samples 2-1 and 2-2 are sample fabrics treated with a penetrant in the first oxidation step ST11.

Further, samples 1-1 and 2-1 are sample fabrics which were subjected to the dechlorination step ST13 and the drying step without being subjected to the second oxidation step ST12. On the other hand, samples 1-2 and 2-2 are sample fabrics that were subjected to the second oxidation step ST12.

Each whiteness degree was calculated as L*-3b* according to the CIELAB color system (measured in a micro area) using Macbeth WHITE-EYE3000 (product of Kellmorgen Instruments Corporation)). Further, the whiteness degree after absolute drying is the whiteness degree after the measurement of absolute dry weight according to JIS L-0105 4.3.

TABLE 4

| | | | | Whiteness degree | |
|---|---|---|---|---|---|
| | Addition | | Moisture | Before | After |
| | of | Treatment | absorptivity | absolute | absolute |
| No. | Penetrant | of NaClO₂ | (%) | drying | drying |
| 1-1 | Added | Not | 8.1 | 83.10 | 62.62 |
| | | performed | | | |
| 1-2 | | Performed | 8.4 | 88.70 | 72.67 |
| 2-1 | Not added | Not | 8.0 | 83.12 | 61.63 |
| | | performed | | | |
| 2-2 | | Performed | 8.6 | 88.07 | 76.40 |
| Unbleached | — | — | 6.7 | 43.27 | 43.59 |

The comparison between samples 1-1 and 1-2 and between samples 2-1 and 2-2 shown in Table 4 revealed that subjecting the sample to the oxidation in the second oxidation step ST12 increased the moisture absorptivity. This indicates that the aldehyde group, which is a by-product of the first oxidation step ST11, is oxidized to a carboxyl group in the second oxidation step ST12.

Further, the comparison between samples 1-2 and 2-2 revealed that the hygroscopic property of sample 2-2, which was subjected to the TEMPO oxidation using a penetrant, increased. This confirmed infiltration of the first reaction solution into the cellulose fiber during the TEMPO oxidization.

### Example 2

In regard to the hydrophilic treatment method of the present invention, in the present Example, evaluation was performed as to how the variation in reaction time influences the processing degree and fabric property in the first oxidation step ST11 (TEMPO oxidization).

Test Conditions

### (a) Test Step

The same test step as in Example 1 was used in this

Example, except that the reaction time in the first oxidation step ST11 was varied for each sample. More specifically, five samples were subjected to the first oxidation step ST11, and the reaction was stopped for each sample when the reaction time reached 1 minute, 2.5 minutes, 5 minutes, 10 minutes, and 15 minutes, respectively.

Further, for comparison, another sample was prepared by performing the first oxidation step ST11 without a TEMPO catalyst.

Evaluation Result

Table 5 shows evaluation results regarding moisture absorptivity, whiteness degree, bursting strength, and degree of polymerization of the multiple samples (3-1 to 3-5, a sample without TEMPO, an unbleached sample, and an untreated sample.

Samples 3-1 to 3-5 are sample fabrics produced by varying the reaction time in the TEMPO oxidation in the first oxidation step ST11.

The “TEMPO-free” sample is a sample fabric oxidized by performing the first oxidation step ST11 without a TEMPO catalyst.

The “unbleached” and “untreated” samples respectively represent an unbleached sample fabric and an untreated cellulose fiber.

Whiteness degree was measured in the same method as in Example 1.

The bursting strength was measured according to JIS L-1018 8.17A.

The degree of polymerization was measured as follows.

In the specification of the present invention, the degree of polymerization designates an average number of glucose components contained in a cellulose molecule. Further, the molecular weight can be found by multiplying the degree of polymerization by 162. In the present Example, the degree of polymerization was found as follows. The fiber obtained from each sample fabric was previously reduced using sodium borohydride, thereby reducing the residual aldehyde group to alcohol. The resulting fiber was dissolved in a 0.5 M copper-ethylenediamine solution to be subjected to viscometric measurement.

Because the copper-ethylenediamine solution is an alkaline solution, β-elimination reaction may occur during the dissolution process if the aldehyde group remains in the oxycellulose. This may decrease the molecular weight. To prevent this defect, in this Example, the copper-ethylenediamine solution was subjected to reduction treatment in advance, thereby converting the aldehyde group into an alcoholic hydroxyl group.

The formula to calculate the degree of polymerization of the cellulose based on the viscosity of the cellulose dissolved in a 0.5 M copper-ethylenediamine solution was found by reference to the following documents.
Documents: Isogai, A., Mutoh, N., Onabe, F., Usuda, M., “Viscosity measurements of cellulose/SO₂-amine-dimethylsulfoxide solution”, Sen'i Gakkaishi, 45, 299-306 (1989).

TABLE 5

| | | | Whiteness degree | | | |
|---|---|---|---|---|---|---|
| | | Moisture | Before | After | Bursting | Degree of |
| | Reaction | absorptivity | absolute | absolute | strength | polymerization |
| No. | time | (%) | drying | drying | (kgf/cm²) | (DPw) |
| 3-1 | 1 minutes | 8.1 | 90.13 | 85.74 | 5.5 | 982 |
| 3-2 | 2.5 minutes | 8.5 | 90.34 | 84.72 | 5.0 | 762 |
| 3-3 | 5 minutes | 8.9 | 89.58 | 82.34 | 4.3 | 660 |
| 3-4 | 10 minutes | 9.2 | 89.72 | 81.94 | 3.9 | 618 |
| 3-5 | 15 minutes | 9.4 | 90.03 | 80.90 | 3.4 | 582 |
| TEMPO-free | — | 7.4 | 89.28 | 87.93 | 6.1 | 1187 |
| Unbleached | — | 6.9 | 44.35 | 42.95 | 6.9 | — |
| Untreated | — | — | — | — | — | 1568 |

As shown in Table 5, even when the reaction time was 1 minute (sample 3-1), the moisture absorptivity was greater than that of the unbleached sample fabric, confirming that the hydrophilicity was increased.

Further, for each sample, the whiteness degree after absolute drying decreased and yellow discoloration was observed after heating. The coloring was about 5 points in whiteness degree.

Further, the degree of polymerization tended to decrease as the reaction time increased; however, the sample subjected to 1-minute reaction (sample 3-1) retained the degree of polymerization twice as much as that of the sample fabric subjected to the hydrophilic treatment according to a hitherto known treatment method. Thus, it was confirmed that deterioration in the fabrics strength of the sample was prevented.

The hitherto known treatment method used above was a method in which the sample fabric was subjected to the hydrophilic treatment of the cellulose oxidization treatment method disclosed in Patent Document 1. In the present invention, this corresponds to the hydrophilic treatment in which only the first oxidation step ST11 is performed.

### Example 3

In regard to the hydrophilic treatment method of the present invention, in the present Example, evaluation was performed as to how the concentration of the re-oxidizing agent (sodium hypochlorite) used in the first oxidation step ST11 (TEMPO oxidization) influences the processing degree or the fabric property.

### Test Conditions

### (a) Test Step

The test step was performed in the same manner as in Example 1, except that the concentration of the sodium hypochlorite, i.e., the first reaction solution used in the first oxidation step ST11 was varied for each sample.

The test standard was as follows: the amount of a 4.9% aqueous solution of sodium hypochlorite to be added was varied to 6.7 g/L, 11.3 g/L, 22.5 g/L, 45 g/L, and 90 g/L.

Evaluation Result

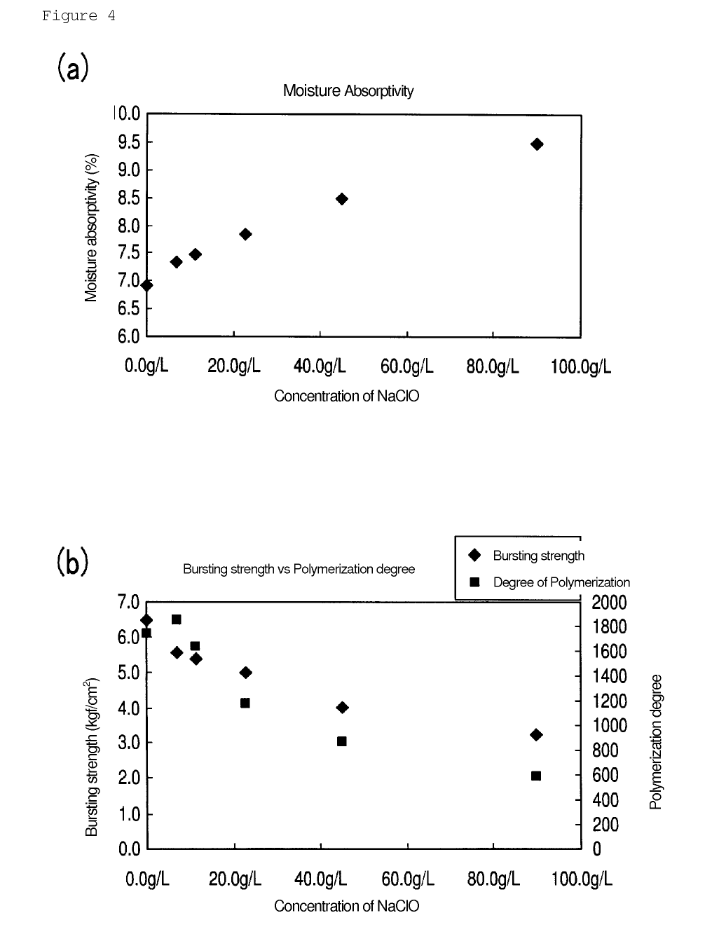

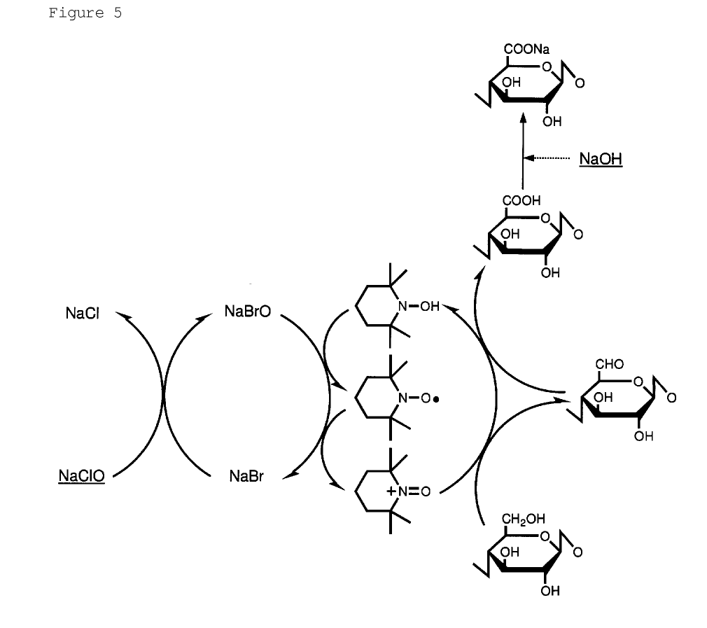

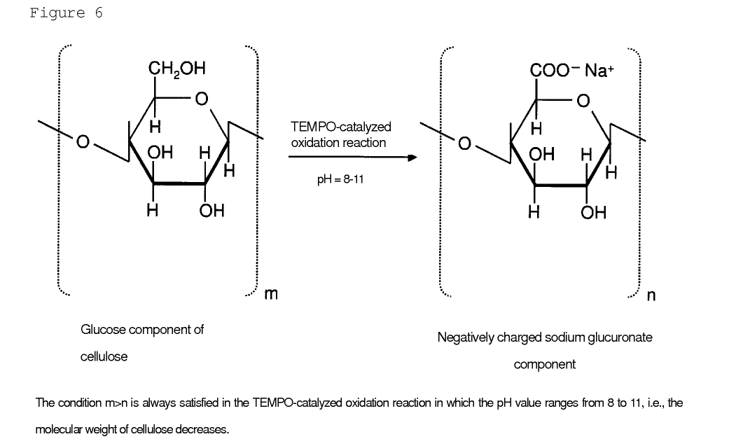

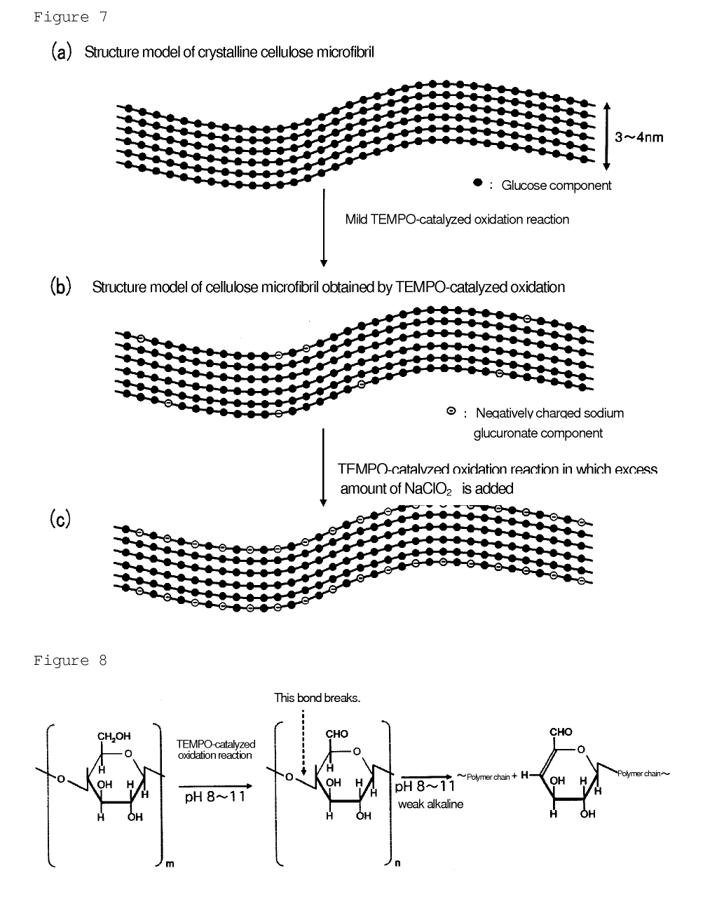

Table 6 shows evaluation results regarding moisture absorptivity, whiteness degree, bursting strength, degree of polymerization, and carboxylate contents of the multiple samples (4-1 to 4-5, unbleached sample, and untreated sample) produced in the above test step. FIG. 4(a) shows a graph plotting the correlation between the moisture absorptivity and the sodium hypochlorite concentration, and FIG. 4(b) shows a graph plotting the correlation between the sodium hypochlorite concentration and the bursting strength/degree of polymerization.

The carboxylate contents were measured by using conductometric titration.

Samples 4-1 to 4-5 are sample fabrics subjected to TEMPO oxidation using first reaction solutions with variable concentrations of the sodium hypochlorite. The “unbleached” and “untreated” samples designate an unbleached sample fabric and an untreated cellulose fiber, respectively.

TABLE 6

| | | | Whiteness degree | | | | |
|---|---|---|---|---|---|---|---|
| | | Moisture | Before | After | Bursting | Dgree of | Carboxylate |
| | NaClO | absorptivity | absolute | absolute | strength | polymerization | contents |
| No. | Concentration | (%) | drying | drying | (kgf/cm²) | (DPw) | (mmol/g) |
| 3-1 | 6.7 g/L | 7.4 | 88.86 | 87.06 | 5.6 | 1853 | 0.085 |
| 3-2 | 11.3 g/L | 7.5 | 88.63 | 87.04 | 5.4 | 1633 | 0.099 |
| 3-3 | 22.5 g/L | 7.8 | 88.9 | 86.26 | 5.0 | 1176 | 0.130 |
| 3-4 | 45.0 g/L | 8.5 | 89.33 | 85.19 | 4.0 | 859 | 0.212 |
| 3-5 | 90.0 g/L | 9.5 | 90.01 | 82.84 | 3.2 | 586 | 0.323 |
| Unbleached | — | 6.9 | 46.52 | 45.07 | 6.5 | 1739 | — |
| Untreated | — | 6.7 | — | — | — | 1702 | 0.055 |

As shown in Table 6, it was revealed that as the concentration of the sodium hypochlorite in the first reaction solution, a greater carboxylate contents were introduced into the cellulose fiber. Further, the increase in carboxyl content tended to increase the amount of Na ion or Ca ion adhered during the washing process, thereby greatly increasing the moisture absorptivity.

On the other hand, the increased concentration of the sodium hypochlorite in the first reaction solution tended to decrease the degree of polymerization and the fabric strength. However, it was confirmed that the decrease in strength was not significant insofar as the concentration of the sodium hypochlorite (4.9% aqueous solution) is not more than 22.5 g/L (about 15 mmol/L).

### Example 4

In regard to the hydrophilic treatment method of the present invention, in the present Example, evaluation was performed as to how the concentration of the TEMPO catalyst and the concentration of the re-oxidizing agent (sodium hypochlorite) used in the first oxidation step ST11 (TEMPO oxidization) influence the fabric strength.

Test Condition

### (a) Test Step

The test step was performed in the same manner as in Example 1, except that the TEMPO concentration and the concentration of the sodium hypochlorite in the first reaction solution used in the first oxidation step ST11 were varied for each sample.

Table 7 below shows the test standard.

TABLE 7

| Standard | a | B | c | d |
|---|---|---|---|---|
| TEMPO | 0.33 g/L | 0.66g/L | 1 g/L | 2 g/L |
| Concentration | | | | |

| Standard | 1 | 2 |
|---|---|---|
| NaClO | 22.5 g/L | 45 g/L |
| Concentration | | |

Evaluation Result

Table 8 shows evaluation results regarding moisture absorptivity, carboxylate contents, degree of polymerization, whiteness degree, bursting strength, and bending resistance of the multiple samples (a-1 to d-1, a-2 to d-2, unbleached sample, and conventional product) prepared in the above test step. The bending resistance was measured according to JIS L-1018 8.22E.

The letters (a to d) in the sample code correspond to the test standard of TEMPO concentration, while the numbers (1 and 2) correspond to the test standard of NaClO concentration. For example, sample a-1 has a TEMPO concentration of 0.33 g/L (standard a) and a NaClO concentration of 22.5 g/L (standard 1).

The “unbleached sample” is an unbleached sample fabric.

The “conventional product” is a sample obtained by immersing a sample fabric into a reaction solution containing monochloroacetic acid (200 g/L) and sodium hydroxide (50 g/L), and subjecting the sample to partial carboxylmethylation under a reaction temperature of 25° C. and the reaction time of 24 hours.

TABLE 8

| | | | | | | Whiteness degree | | | | |
|---|---|---|---|---|---|---|---|---|---|---|
| | TEMPO | NaClO | Moisture | Carboxylate | Degree of | Before | After | | Bursting | Bending |
| | Concentration | Concentration | absorptivity | contents | polymerization | absolute | absolute | Decrease in | strength | resistance |
| No. | (g/L) | (g/L) | (%) | (mmol/g) | (DPw) | drying | drying | whiteness | (kgf/cm²) | (cN) |
| a-1 | 0.33 | 22.5 | 7.6 | 0.135 | 1603 | 89.0 | 87.3 | −1.7 | 5.7 | 29 |
| b-1 | 0.66 | | 7.7 | 0.141 | 1515 | 89.2 | 87.5 | −1.7 | 5.6 | 31 |
| c-1 | 1 | | 7.7 | 0.165 | 1651 | 89.2 | 87.4 | −1.8 | 5.5 | 30 |
| d-1 | 2 | | 7.7 | 0.137 | 1606 | 89.1 | 87.6 | −1.5 | 5.8 | 31 |
| a-2 | 0.33 | 45.0 | 7.9 | 0.234 | 1102 | 90.4 | 87.8 | −2.6 | 5.2 | 34 |
| b-2 | 0.66 | | 8.0 | 0.177 | 1315 | 89.9 | 88.1 | −1.8 | 5.4 | 36 |
| c-2 | 1 | | 8.1 | 0.188 | 1412 | 90.0 | 88.0 | −2.0 | 5.5 | 36 |
| d-2 | 2 | | 8.1 | 0.213 | 1375 | 89.7 | 87.7 | −2.0 | 5.6 | 37 |
| Unbleached | — | — | 7.1 | — | 1923 | 59.1 | 60.6 | −28.5 | 5.8 | 26 |
| Conventional | — | — | 7.5 | — | 1372 | — | — | — | 4.9 | 38 |
| product | | | | | | | | | | |

As shown in Table 8, the comparison among samples a-1 to d-1, and a-2 to d-2, which were prepared with variable TEMPO concentrations revealed that no significant tendency was found by the variation in TEMPO catalyst concentration.

Moreover, the degree of polymerization of samples a-1 to d-1 were all greater than those of the conventional product. The textures of the samples were also improved.

No significant decrease in bursting strength was observed in any of the samples.

### Example 5

As shown in FIG. 2(a) and FIG. 3(a), since the first oxidation step ST11 was performed in an open reaction system, there was some sodium hypochlorite that was not efficiently utilized in the reaction.

Therefore, in the present Example, evaluation was performed on a treatment method in which the first oxidation step ST11 (TEMPO oxidization) is performed by immersing a sample fabric in a treatment bath containing a TEMPO catalyst and sodium bromide and adding sodium hypochlorite to the treatment bath dropwise so as to adjust the pH value to 10.

Test Condition

### (a) Test Step

The test step was performed in the same manner as in Example 1, except that the TEMPO catalyst concentration was changed to 0.33 g/L, and the sodium bromide concentration was changed to 3.3 g/L. Further, the reaction time and the reaction temperature in the first oxidation step ST11 were varied for each sample. Table 9 below shows the test standard.

TABLE 9

| Standard | A | B | C |
|---|---|---|---|
| Reaction | 15° C. | 25° C. | 45° C. |
| temperature | | | |

| Standard | 1 | 2 | 3 |
|---|---|---|---|
| Reaction time | 1 minutes | 5 minutes | 15 minutes |

Evaluation Result

Table 10 shows evaluation results regarding carboxylate contents, degree of polymerization, whiteness degree, and moisture absorptivity of the multiple samples (A-1 to C-1, A-2 to C-2, A-3 to C-3, unbleached sample, and untreated sample) prepared in the above test step.

The letters (A to C) in the sample code correspond to the test standard of reaction temperature, while the numbers (1 to 3) correspond to the test standard of reaction time. For example, sample A-1 was subjected to a reaction at 15° C. (standard A) for 1 minute (standard 1).

The “unbleached” and “untreated” samples are an unbleached sample fabric and an untreated cellulose fiber, respectively.

TABLE 10

| | | Concentration | | | | Whiteness degree | | |
|---|---|---|---|---|---|---|---|---|
| | | Of total NaClO | | Carboxylate | Degree of | Before | After | Moisture |
| | Reaction | added | Reaction | contents | polymerization | absolute | absolute | absorptivity |
| No. | temperature | (g/L) | time | (mmol/g) | (DPw) | drying | drying | (%) |
| A-1 | 15 | 0.6 | 1 | 0.091 | 1716 | 89.3 | 88.0 | 7.0 |
| B-1 | | 0.8 | 5 | 0.097 | 1716 | 89.2 | 87.7 | 7.1 |
| C-1 | | 2.9 | 15 | 0.105 | 1638 | 89.4 | 87.6 | 7.2 |
| A-2 | 25 | 0.7 | 1 | 0.068 | 1605 | 89.5 | 88.0 | 7.0 |
| B-2 | | 2.3 | 5 | 0.091 | 1625 | 89.2 | 87.8 | 7.1 |
| C-2 | | 4.5 | 15 | 0.130 | 1617 | 89.6 | 87.7 | 7.3 |
| A-3 | 45 | 16.9 | 1 | 0.093 | 1576 | 90.9 | 89.84 | 7.3 |
| B-3 | | 29.7 | 5 | 0.140 | 1519 | 90.86 | 89.78 | 7.4 |
| C-3 | | 74.7 | 15 | 0.402 | 866 | 90.99 | 86.82 | 9.0 |
| Unbleached | — | | 0 | — | 1740 | 59.3 | 58.8 | 7.0 |
| Untreated | — | | — | — | 1538 | 93.5 | 93.0 | 6.6 |

As shown in Table 10, in the present Example, as the reaction temperature increased, the carboxylate contents to be introduced into the cellulose increased; further, the decrease in degree of polymerization for each sample was significantly reduced.

This is presumably because the hydrophilic treatment method of the present Example is arranged such that the reaction temperature is increased to enable easy introduction of a carboxyl group, and a minimum amount of the sodium hypochlorite serving as an oxidizing agent is added by degrees.

Further, the hydrophilic treatment method of the present Example enabled reduction of the amount of sodium hypochlorite to about two thirds, compared with the method in which the first reaction solution containing sodium hypochlorite is prepared, and the sample fabric is immersed in the first reaction solution.

### Example 6

In the present Example, the first and second oxidation steps oxidize the C6 position of cellulose fiber to a carboxyl group; however, it is assumed that the oxidation steps also oxidize the C2 position or C3 position of the cellulose fiber, thereby partially producing ketone. Therefore, in the present embodiment, reduction treatment is performed after the second step (after the dehalogenation treatment) using a reducing agent, thereby reducing the ketone produced at the C2 position or C3 position of the cellulose fiber to alcohol. The resulting fabric (hydrophilic cellulose fiber) was evaluated for functionality assessment.

Test Condition

### (a) Test Step

In the same manner as in Example 1 above and under the conditions shown in Tables 11 to 14, the first oxidation step ST11 for performing TEMPO oxidization of an unbleached sample fabric (cellulose fiber), the second oxidation step ST12 for further oxidizing the oxycellulose fiber, and the dehalogenation step ST13 for removing chlorine from the oxycellulose fiber were performed. The resulting oxycellulose fiber after the dehalogenation treatment was further subjected to reduction treatment using NaBH₄; subsequently, a drying step was performed to dry the treated sample fabric.

### (b) TEMPO Oxidization (First Oxidation Step ST11)

Under the condition shown in Table 11 below, the fabric was subjected to TEMPO oxidation, followed by an oxidation step in the same manner as in Example 1.

TABLE 11

| Factor | Condition | |
|---|---|---|
| Weight of fabric | 5 | g |
| TEMPO catalyst | 0.5 | g/L |
| NaBr | 5 | g/L |
| 5% NaClO | 60 | g/L |
| Reaction time | 10 | minutes |
| pH | 10 | |
| Reaction temperature | 25° | C. |

### (c) Oxidation Step (Second Oxidation Step ST12)

Under the condition shown in Table 12 below, the sample fabric (oxycellulose fiber) was subjected to oxidation, thereby oxidizing the aldehyde group introduced in the cellulose by TEMPO oxidization into a carboxyl group, as in Example 1.

TABLE 12

| Factor | Condition | |
|---|---|---|
| Weight of fabric | 5 | g |
| 25% NaCl0₂ | 20% | owf |
| CG1000 | 1 | g/L |
| Reaction time | 90 | minutes |
| pH | 3.8 | |
| Reaction temperature | 80° | C. |

### (d) Dechlorination Step (Dehalogenation Step ST13)

In the same manner as in Example 1 and under the condition shown in Table 13 below, chlorine was removed from the sample fabric oxidized in the second oxidation step ST12.

TABLE 13

| Factor | Condition | |
|---|---|---|
| Weight of fabric | 5 | g |
| 35% H₂O₂ | 5% | owf |
| PLC7000 | 0.4 | g/L |
| Reaction time | 90 | minutes |
| pH | 3.8 | |
| Reaction temperature | 80° | C. |

Reduction Step

Under the condition shown in Table 14 below, the sample fabric, which had been subjected to the dechlorination treatment, was further subjected to a step for reducing ketone contained in the cellulose fiber using NaBH₄.

TABLE 14

| Factor | Condition | |
|---|---|---|
| Weight of fabric | 5 | g |
| NaBH₂ | 5% | owf |
| Reaction time | 20 | minutes |
| pH | 8 | |
| Reaction temperature | 25° | C. |

### (e) Washing and Drying Step

After the reduction treatment was completed, the sample fabric was sequentially washed with cold water (5 minutes, once), hot water (60° C., 10 minutes, once), and cold water (5 minutes, twice). Thereafter, the sample fabric was dried in a drying chamber at 40° C.

Evaluation Result

Table 15 shows evaluation results regarding whiteness degree for the multiple samples (4-1 to 4-5) produced in the above test steps.

Samples 4-1 to 4-5 are sample fabrics subjected to reduction treatments with different NaBH₄ proportions.

The carboxylate contents, degree of polymerization, and whiteness degree shown in Table 15 were measured in the same manner as in the Examples above. The “bleached fabric” was a sample fabric obtained by refining the unbleached sample and subjecting the refined sample to bleaching with NaClO₂, and then with H₂O₂.

TABLE 15

| | | | | | | | | Whiteness | | |
|---|---|---|---|---|---|---|---|---|---|---|
| | TEMPO | NaBr | NaClO | Reaction | NaBH₄ | Carboxylate | Degree of | degree | | Decrease |
| | Concen- | Concen- | Concentration | time | Concentration | contents | polymerization | After | After | in |
| No. | tration (g/L) | tration (g/L) | (g/L) | (minutes) | (%/owf) | (mmol/g) | (DPw) | TEMPO | drying | whiteness |
| 4-1 | 0.5 | 5.0 | 60 | 10 | 0 | 0.407 | 833 | 89.0 | 85.2 | −3.8 |
| 4-2 | | | | | 0.1 | 0.394 | 876 | 89.4 | 86.2 | −3.2 |
| 4-3 | | | | | 0.5 | 0.349 | 935 | 89.3 | 86.4 | −2.9 |
| 4-4 | | | | | 2.0 | 0.324 | 968 | 89.9 | 88.2 | −1.7 |
| 4-5 | | | | | 5.0 | 0.323 | 1046 | 90.3 | 88.8 | −1.5 |
| Unbleached | — | — | — | — | — | — | 2015 | 65.1 | 64.9 | −0.2 |
| Fabric | — | — | — | — | — | 0.066 | | 93.2 | 92.4 | −0.8 |
| after | | | | | | | | | | |
| bleaching | | | | | | | | | | |

As shown in Table 15, the decrease in whiteness by heat was significant in sample 4-1, which was not subjected to the reduction treatment using NaBH₄. In contrast, the decrease in whiteness by heat was suppressed in samples 4-2 to 4-5 subjected to reduction treatments with different NaBH₄ concentrations. This indicates that the reducing agent served to reduce ketone, which may cause yellow discoloration.

### Example 7

In regard to the hydrophilic treatment method of the present invention, in the present Example, evaluation was performed as to how the concentration of the re-oxidizing agent (sodium hypochlorite) in the first oxidation step ST11 (TEMPO oxidization), and execution/omission of the reduction treatment affect the fabric strength.

### (a) Test Step

This test step used the same manner as in Example 6, except that the concentration of sodium hypochlorite in the first reaction solution used in the first oxidation step ST11 was varied for the multiple samples; further, the evaluation was made for both the case with and the case without NaBH₄ treatment.

Table 16 below shows the test standard. Sample 5-4 is the same as sample d-2 in Example 4.

TABLE 16

| | TEMPO | NaClO | | Carboxylate | Degree of | Whiteness degree | | | Moisture |
|---|---|---|---|---|---|---|---|---|---|
| | Concentration | Concentration | NaBH₄ | contents | polymerization | After | After | Decrease in | absorptivity |
| No. | (g/L) | (g/L) | treatment | (mmol/g) | (DPw) | TEMPO | drying | whiteness | (%) |
| 5-1 | 2.0 | 30 | Performed | 0.141 | 1109 | 89.6 | 88.8 | −0.8 | 7.9 |
| 5-2 | | | Not | 0.085 | 1307 | 88.1 | 86.4 | −1.7 | 8.0 |
| | | | performed | | | | | | |
| 5-3 | | 45 | Performed | 0.258 | 1157 | 89.9 | 89.0 | −0.9 | 8.0 |
| 5-4 | | | Not | 0.208 | 1309 | 89.1 | 86.9 | −2.2 | 8.4 |
| | | | performed | | | | | | |
| 5-5 | | 60 | Performed | 0.256 | 1127 | 89.9 | 89.0 | −0.8 | 8.6 |
| 5-6 | | | Not | 0.264 | 1234 | 89.1 | 86.7 | −2.5 | 8.7 |
| | | | performed | | | | | | |
| Unbleached | — | — | — | — | 2009 | 65.1 | 65.2 | 0.1 | 7.2 |
| Fabric | — | — | — | 0.040 | — | 92.3 | 92.0 | −0.3 | 7.1 |
| after | | | | | | | | | |
| bleaching | | | | | | | | | |

Evaluation Result

Table 16 shows evaluation results regarding moisture absorptivity, carboxylate contents, degree of polymerization, and whiteness degree of the multiple samples (5-1 to 5-6) produced in the above test step.

The moisture absorptivity, carboxylate contents, degree of polymerization, and whiteness degree were measured in the same manner as in the Examples above. The “unbleached” sample designates an unbleached sample fabric, and “bleached” sample designates a bleached sample fabric obtained by refining the unbleached sample and subjecting the refined sample to bleaching with NaClO₂, and then with H₂O₂.

As shown in Table 16, among samples 5-1 to 5-5 prepared by varying the NaClO concentration, samples 5-1, 5-3, and 5-5, which were subjected to the NaBH₄ treatment, and samples 5-2, 5-4, and 5-6, which were not subjected the NaBH₄ treatment, were compared. The results show that the decrease in whiteness was suppressed in the samples subjected to the NaBH₄ treatment even with the variable NaClO concentrations.

### Example 8

In regard to the hydrophilic treatment method of the present invention, in the present Example, evaluation was performed as to how the variation in type of the promoter in the first oxidation step ST11 (TEMPO oxidization), and the execution/omission of the subsequent reduction treatment affect the fabric strength.

### (a) Test Step

This test step used the same manner as in Example 6, except that different kinds of promoters were used in the first oxidation step ST11 respectively for the multiple samples; further, the evaluation was made for both the case with and the case without NaBH₄ treatment Table 17 below shows the test standard.

TABLE 17

| | | | | | | | | Whiteness | | |
|---|---|---|---|---|---|---|---|---|---|---|
| | | NaBH₄ | TEMPO | Promotor | NaClO | Carboxylate | Degree of | degree | | Decrease |
| | | Concentration | Concen- | Concen- | Concentration | contents | polymerization | After | After | in |
| No. | Promoter | (%/owf) | tration (g/L) | tration (g/L) | (g/L) | (mmol/g) | (DPw) | TEMPO | drying | whiteness |
| 6-1 | NaBr | 5 | 0.5 | 5.0 | 60 | 0.323 | 1046 | 90.3 | 88.8 | −1.5 |
| 6-2 | | — | | | | 0.377 | 911 | 89.1 | 85.6 | −3.5 |
| 6-3 | NaCl | 5 | | | | 0.271 | 945 | 90.4 | 89.3 | −1.2 |
| 6-4 | | — | | | | 0.296 | 1046 | 89.6 | 87.4 | −2.1 |
| 6-5 | Na₂SO₄ | 5 | | | | 0.302 | 985 | 90.7 | 89.0 | −1.7 |
| 6-6 | | — | | | | 0.213 | 1055 | 89.5 | 87.2 | −2.2 |
| Unbleached | — | — | — | — | — | — | 1627 | 65.0 | 65.1 | 0.1 |
| Fabric | — | — | — | — | — | 0.066 | — | 92.4 | 92.4 | 0.0 |
| after | | | | | | | | | | |
| bleaching | | | | | | | | | | |

Evaluation Result

Table 17 shows evaluation results regarding carboxylate contents, degree of polymerization, and whiteness degree of the multiple samples (6-1 to 6-6) produced in the above test step.

The carboxyl contents, degree of polymerization, and whiteness degree were measured in the same manner as in the Examples above. The “unbleached” sample designates an unbleached sample fabric, and “bleached” sample designates a bleached sample fabric obtained by refining the unbleached sample and subjecting the refined sample to bleaching with NaClO₂, and then with H₂O₂.

As shown in Table 17, the introduction of a COOH group in the cellulose fiber was confirmed in the samples using NaCl or sodium sulfate (salt cake) as the promoter. In the samples using NaCl or sodium sulfate (salt cake) as the promoter, although the degree of polymerization was tended to decrease, generation of ketone was suppressed, compared with the sample using NaBr, thereby suppressing yellow discoloration (decrease in whiteness) by heat. Therefore, the samples using NaCl or sodium sulfate (salt cake) are useful.

### Example 9

In the present Example, a functionality assessment was performed with respect to samples prepared by using a TEMPO derivative in the first oxidation step instead of the TEMPO catalyst used in the first oxidation step.

### (a) Test Step

This test step used the same manner as in Example 6, except that the evaluation was made using different kinds of TEMPO catalysts in the first oxidation step ST11 for each of the multiple samples.

Table 18 shows TEMPO derivatives used in the test. Table 19 below shows the test standard.

TABLE 18

| | | Catalyst | | | Reaction |
|---|---|---|---|---|---|
| | | concentration | NaBr | NaClO | Time |
| No | TEMPO | (g/L) | (g/L) | (g/L) | (minutes) |
| 7-1 | TEMPO | 0.1 | 1 | 90 | 15 |
| 7-2 | 4-acetamide | | | | |
| | TEMPO | | | | |
| 7-3 | 4-methoxy | | | | |
| | TEMPO | | | | |
| 7-4 | 4-hydroxy | | | | |
| | TEMPO | | | | |
| 7-5 | 4-carboxy | | | | |
| | TEMPO | | | | |
| 7-6 | 4-oxo | | | | |
| | TEMPO | | | | |
| 7-7 | Adamantane- | 0.007 | 0.07 | 60 | 10 |
| | TEMPO | | | | |

TABLE 19

| | | | | Whiteness | | |
|---|---|---|---|---|---|---|
| | | Carboxylate | Degree of | degree | | Decrease |
| | | contents | Polymerization | After | After | in |
| No. | TEMPO | (mmol/g) | (DPw) | TEMPO | drying | whiteness |
| 7-1 | TEMPO | 0.368 | 617 | 90.0 | 85.7 | −4.3 |
| 7-2 | 4- | 0.312 | 495 | 90.1 | 84.7 | −5.4 |
| | acetamide | | | | | |
| | TEMPO | | | | | |
| 7-3 | 4-methoxy | 0.312 | 517 | 90.3 | 85.1 | −5.2 |
| | TEMPO | | | | | |
| 7-4 | 4-hydroxy | 0.099 | 721 | 89.0 | 87.1 | −2.0 |
| | TEMPO | | | | | |
| 7-5 | 4-carboxy | 0.222 | 509 | 89.6 | 85.8 | −3.8 |
| | TEMPO | | | | | |
| 7-6 | 4-oxo | 0.059 | 790 | 89.2 | 87.3 | −1.9 |
| | TEMPO | | | | | |
| 7-7 | Adamantane- | 0.220 | 635 | 89.4 | 82.1 | −7.3 |
| | TEMPO | | | | | |
| Unbleached | — | — | 2151 | 65.5 | 66.5 | 1.0 |
| Fabric | — | 0.041 | — | 93.1 | 92.8 | −0.3 |
| after | | | | | | |
| bleaching | | | | | | |

Evaluation Result

Table 19 shows evaluation results regarding carboxylate contents, degree of polymerization, and whiteness degree of the multiple samples (7-1 to 7-7) produced in the above test step.

The carboxylate contents, degree of polymerization, and whiteness degree were measured in the same manner as in the Examples above. The “unbleached” sample designates an unbleached sample fabric, and “bleached” sample designates a bleached sample fabric obtained by refining the unbleached sample and subjecting the refined sample to bleaching with NaClO₂, and then with H₂O₂.

As shown in Table 19, it was confirmed that TEMPO enabled maximum introduction of COOH group, while suppressing the decrease in degree of polymerization.

Although 4-acetamide TEMPO and 4-methoxy TEMPO have similar behaviors, the suppression of the decreases in degree of polymerization and in whiteness degree was slightly better in 4-methoxy TEMPO than 4-acetamide TEMPO.

The above results revealed that not only TEMPO but also TEMPO derivatives enabled introduction of a COOH group.

### Comparative Example

In regard to the production step in Example 9, in the present Comparative Example, a functionality assessment was performed by evaluating how the omissions of the second oxidation step and the dechlorination step affect the carboxylate contents, degree of polymerization, and whiteness degree.

### (a) Test Step

This test step used the same manner as in Example 8, except that different kinds of TEMPO catalysts were used in the first oxidation step ST11 for each of the multiple samples. Each sample fabric was washed (5 minutes, three times) after the first oxidation step without being subjected to the second oxidation step and the dechlorination step. Thereafter, the sample fabrics were dried in a drying chamber at 40° C.

Table 20 below shows the test standard.

TABLE 20

| | | Carboxylate | Degree of | Whiteness degree | | Decrease |
|---|---|---|---|---|---|---|
| | | contents | Polymerization | After | After | in |
| Sample No. | TEMPO | (mmol/g) | (DPw) | TEMPO | drying | whiteness |
| 1 | TEMPO | 0.305 | 261 | 83.9 | 68.9 | −15.0 |
| 2 | 4-acetamide | 0.306 | 249 | 84.7 | 66.1 | −18.5 |
| | TEMPO | | | | | |
| 3 | 4-methoxy | 0.297 | 249 | 83.9 | 66.2 | −17.7 |
| | TEMPO | | | | | |
| 4 | 4-hydroxy | 0.126 | 514 | 83.5 | 74.0 | −9.5 |
| | TEMPO | | | | | |
| 5 | 4-carboxy | 0.204 | 345 | 84.0 | 70.8 | −13.2 |
| | TEMPO | | | | | |
| 6 | 4-oxo TEMPO | — | — | — | — | — |
| 7 | Adamantane- | 0.191 | 271 | 82.5 | 56.6 | −25.9 |
| | TEMPO | | | | | |
| Unbleached | — | — | 2043 | 67.4 | 66.9 | −0.5 |
| Fabric | — | 0.052 | — | 92.9 | 91.9 | −1.1 |
| after | | | | | | |
| bleaching | | | | | | |

Evaluation Result

Table 20 shows evaluation results regarding carboxylate contents, degree of polymerization, and whiteness degree of the multiple samples (1 to 7) produced in the above test step.

The carboxylate contents, degree of polymerization, and whiteness degree were measured in the same manner as in the Examples above. The “unbleached” sample designates an unbleached sample fabric, and “bleached” sample designates a bleached sample fabric obtained by refining the unbleached sample and subjecting the refined sample to bleaching with NaClO₂, and then with H₂O₂.

The comparison between Tables 20 and 19 revealed that the degree of polymerization greatly decreased by the omission of the second oxidation step and the dechlorination step. Further, it was also revealed that the decrease in whiteness was much more significant compared with Example 7 in Table 19, although the extent of decrease varied due to the different generation amounts of aldehyde and ketone in the respective cellulose fibers.

### Example 10

In the present Example, 4-methoxy TEMPO was used in the first oxidation step instead of TEMPO, and evaluation was performed as to how the concentrations of 4-methoxy TEMPO, promoter (NaBr), and re-oxidizing agent (sodium hypochlorite) affect the fabric strength.

### (a) Test Step

This test step used the same manner as in Example 6, except that the evaluation was made using 4-methoxy TEMPO instead of TEMPO, by varying concentrations of 4-methoxy TEMPO, promoter (NaBr), and re-oxidizing agent (sodium hypochlorite) respectively for the multiple samples.

Table 21 below shows the test standard.

TABLE 21

| | 4-methoxy | | | | | | Degree | | | |
|---|---|---|---|---|---|---|---|---|---|---|
| | TEMPO | NaBr | NaClO | Reaction | | Carboxylate | of | Whiteness degree | | Decrease |
| | Concentration | Concentration | Concentration | Time | NaBH₄ | contents | Polymerization | After | After | in |
| Sample No. | (g/L) | (g/L) | (g/L) | (minutes) | treatment | (mmol/g) | (DPw) | TEMPO | drying | whiteness |
| 8-1 | 0.12 | 1.2 | 60 | 10 | Performed | 0.286 | 1223 | 91.4 | 89.2 | −2.2 |
| 8-2 | 0.27 | 2.7 | | | | 0.291 | 1225 | 91.3 | 88.7 | −2.6 |
| 8-3 | 0.36 | 3.6 | | | | 0.312 | 1065 | 91.2 | 88.7 | −2.5 |
| 8-4 | 0.50 | 5.0 | | | | 0.351 | 967 | 91.4 | 88.6 | −2.9 |
| 8-5 | 0.50 | 5.0 | 45 | | | 0.305 | 924 | 91.0 | 89.2 | −1.8 |
| 8-6 | | | 50 | | | 0.357 | 920 | 91.3 | 88.9 | −2.2 |
| 8-7 | | | 55 | | | 0.384 | 844 | 66.7 | 88.5 | −2.8 |
| Unbleached | — | — | — | — | — | — | 2012 | 92.9 | 66.1 | −0.6 |
| Fabric | — | — | — | — | — | 0.065 | — | 93.2 | 92.2 | −0.7 |
| after | | | | | | | | | | |
| bleaching | | | | | | | | | | |

Evaluation Result

Table 21 shows evaluation results regarding carboxylate contents, degree of polymerization, and whiteness degree of the multiple samples (8-1 to 8-7) produced in the above test step.

The carboxylate contents, degree of polymerization, and whiteness degree were measured in the same manner as in the Examples above. The “unbleached” sample designates an unbleached sample fabric, and “bleached” sample designates a bleached sample fabric obtained by refining the unbleached sample and subjecting the refined sample to bleaching with NaClO₂, and then with H₂O₂.

As shown in Table 21, it was revealed that the decrease in degree of polymerization was suppressed as the concentration of 4-methoxy TEMPO decreased, and that 4-methoxy TEMPO tended to more easily introduce a COOH group compared with TEMPO.

### Example 11

In the present Example, a confirmation test was performed regarding the recycle limit of the reaction solution after the TEMPO oxidization, i.e., as to how many times the reaction solution can be used.

### (a) Test Step

In the same manner as in Example 1, the test was performed using a TEMPO catalyst under the reaction condition specified in Table 22. Further, in this test step, the reaction solution after the TEMPO oxidization was collected, and the second (sample 9-2) and third (sample 9-3) TEMPO oxidizations were carried out using different cellulose fibers.

TABLE 22

| Factor | Condition | |
|---|---|---|
| TEMPO catalyst | 0.5 | g/L |
| NaBr | 5 | g/L |
| 5% NaClO | 22.5 | g/L |
| Reaction time | 10 | minutes |
| pH | 10 | |
| Reaction temperature | 25° | C. |

TABLE 23

| | | Carboxylate | Degree of | Whiteness degree | | Reaction |
|---|---|---|---|---|---|---|
| | Number of | contents | polymerization | After | After | Efficiency |
| No. | Times | (mmol/g) | (DPw) | TEMPO | drying | (%) |
| 9-1 | 1 | 0.231 | 1392 | 88.18 | 85.07 | 100 |
| 9-2 | 2 | 0.219 | 1245 | 87.75 | 85.37 | 94.8 |
| 9-3 | 3 | 0.213 | 1233 | 88.04 | 85.36 | 92.3 |
| Unbleached | — | — | — | 65.69 | 66.35 | — |
| Fabric | — | 0.042 | — | 92.11 | 91.62 | — |
| after | | | | | | |
| bleaching | | | | | | |

Evaluation Result

Table 23 shows evaluation results regarding carboxylate contents, degree of polymerization, whiteness degree, and reaction efficiency of the multiple samples (9-1 to 9-3) produced in the above test step.

The carboxylate contents, degree of polymerization, and whiteness degree were measured in the same manner as in the Examples above. The reaction efficiency corresponds to a proportion of carboxyl group generation; the proportion was found assuming that the initial carboxyl amount was 100%.

The “unbleached” sample designates an unbleached sample fabric, and “bleached” sample designates a bleached sample fabric obtained by refining the unbleached sample and subjecting the refined sample to bleaching with NaClO₂, and then with H₂O₂.

Table 23 shows the reaction efficiencies when the reaction solution of TEMPO catalyst was recycled. As shown therein, it was revealed that the reaction efficiency was kept high, namely, 90%, up to the third recycle. Thus, it was confirmed that the reaction solution is recyclable.

### REFERENCE NUMERALS

200, 300: reaction vessel
200A: beaker
210, 310: reaction solution
215, 315: cellulose fiber (sample fabric)
222, 320: hot water tank (heating device)
223: stirring bar
251: pH electrode
252: nozzle
300A: vinyl bag
301: cap
318: stainless steel pot
320A: oil bath (heating device)
ST11: first oxidation step
ST12: second oxidation step
ST13: dehalogenation step

1. A method for producing hydrophilic cellulose fibers comprising:
a first oxidation step of oxidizing cellulose fibers in a first reaction solution containing an N-oxyl compound and a re-oxidizing agent for the N-oxyl compound; and
a second oxidation step of oxidizing oxycellulose fibers obtained in the first oxidation step in a second reaction solution containing an oxidizing agent for oxidizing aldehyde groups.

2. The method for producing hydrophilic cellulose fibers according to claim 1, wherein the first reaction solution has a pH value of not less than 8 and not more than 12, and the second reaction solution has a pH value of not less than 3 and not more than 7.

3. The method for producing hydrophilic cellulose fibers according to claim 1, wherein the re-oxidizing agent or the oxidizing agent for oxidizing aldehyde groups is a halogen-acid-based oxidizing agent,
the method further comprising a dehalogenation step for dehalogenating oxycellulose fibers obtained in the second oxidation step.

4. The method for producing hydrophilic cellulose fibers according to claim 1, wherein the re-oxidizing agent is a hypohalous acid or a salt thereof, and the oxidizing agent for oxidizing aldehyde groups is a halous acid or a salt thereof.

5. The method for producing hydrophilic cellulose fibers according to claim 1, wherein a buffer is added to the second reaction solution.

6. The method for producing hydrophilic cellulose fibers according to claim 1, wherein a penetrant is added to the first reaction solution.

7. The method for producing hydrophilic cellulose fibers according to claim 1, wherein the first oxidation is carried out by immersing the cellulose fibers in a treatment bath of a solution containing an N-oxyl compound and adding a required amount of the re-oxidizing agent to the treatment bath.

8. The method for producing hydrophilic cellulose fibers according to claim 7, wherein the re-oxidizing agent is added while maintaining the pH value of the treatment bath constant.

9. The method for producing hydrophilic cellulose fibers according to claim 1 further comprising a reduction step for reducing the oxycellulose fiber obtained in the second oxidation step in a reaction solution containing a reducing agent.

10. The method for producing hydrophilic cellulose fibers according to claim 1, wherein the reducing agent used in the reduction step is at least one member selected from the group consisting of thiourea, hydrosulfite, sodium hydrogen sulfite, sodium borohydride, sodium cyanoborohydride, and lithium borohydride.

11. A method for hydrophilic treatment of cellulose fibers comprising:
a first oxidation step of oxidizing cellulose fibers in a first reaction solution containing an N-oxyl compound and a re-oxidizing agent for the N-oxyl compound; and
a second oxidation step of oxidizing oxycellulose fibers obtained in the first oxidation step in a second reaction solution containing an oxidizing agent for oxidizing aldehyde groups.
